(19) United States
(12) Patent Application Publication
(10) Pub. No.: US 2025/0332641 A1
(43) Pub. Date: Oct. 30, 2025

(54) METHODS AND APPARATUS TO MODIFY AND BUILD COMPONENTS

(71) Applicant: GE Avio S.R.L, Rivalta di Torino (IT)

(72) Inventors: Agostino Scialpi, San Giorgio Ionico (IT); Edoardo Maria Peradotto, Torino (IT); Giuseppe Greco, Veglie (IT)

(21) Appl. No.: 18/752,324

(22) Filed: Jun. 24, 2024

(30) Foreign Application Priority Data
Apr. 26, 2024 (IT) 102024000009532

(51) Int. Cl. B22F 12/63; B22F 10/28; B23K 26/342; B33Y 10/00; B33Y 30/00

(52) U.S. Cl. CPC B22F 12/63; B22F 10/28; B23K 26/342; B33Y 10/00; B33Y 30/00

(57) ABSTRACT

Systems, apparatus, articles of manufacture, and methods are disclosed to build and/or modify components. An additive manufacturing apparatus comprising: at least one memory; machine-readable instructions; and processor circuitry to execute machine-readable instructions to: deposit a first layer of material, the first layer of material at a first temperature; compress the first layer of material to form a first compressed layer; deposit a second layer of material, the second layer of material at a second temperature, the first compressed layer to include a first crystalline structure; compress the second layer of material into the first layer of material to form a second compressed layer; deposit a third layer of material, the third layer of material at a third temperature, the second compressed layer to include the first crystalline structure; and compress the third layer of material into the second compressed layer to form a third compressed layer.

### RELATED APPLICATION

This patent claims priority to Italian Patent Application 102024000009532, which was filed on Apr. 26, 2024. Italian Patent Application No. 102024000009532 is hereby incorporated herein by reference in its entirety.

### FIELD OF THE DISCLOSURE

This disclosure relates generally to additive manufacturing methods and, more particularly, to methods and apparatus to modify and build components.

### BACKGROUND

Additive manufacturing (AM) uses computer-aided-design (CAD) software and/or three-dimensional (3D) object scanners to direct hardware to deposit material, layer upon layer, in precise geometric shapes. Each deposited layer bonds to the preceding layer of melted or partially melted material until a final 3D object is created. Some AM devices use lasers or electron beams to selectively melt or partially melt a bed of powdered material, and as the materials cool/cure, the materials fuse together to form the final 3D project. To modify components, a precise area of the component is heated and fused together, with or without a filler material.

Some AM devices alternatively use Directed Energy Deposition (DED) to deposit the material alongside the heat input simultaneously. DED allows for the modification of 3D objects by melting the material in powder or as a wire with a focused energy source as it is deposited by the nozzle of the AM device.

### BRIEF DESCRIPTION OF THE DRAWINGS

FIG. 1A illustrates an example additive manufacturing apparatus.

FIG. 1B illustrates an example post-processing device implemented by the additive manufacturing apparatus of FIG. 1A.

FIG. 1C illustrates an example additive manufacturing system implemented by the additive manufacturing apparatus of FIG. 1A.

FIG. 2 is an example diagram of an example longitudinal weld using the additive manufacturing machine of FIG. 1A.

FIG. 3 is an example diagram of an example circumferential weld using the additive manufacturing machine of FIG. 1A.

FIG. 4A is a top view of the additive manufacturing machine of FIG. 1A.

FIG. 4B is another top view of the additive manufacturing machine of FIG. 1A.

FIG. 5A is a side view of an example implementation of the additive manufacturing machine of FIG. 1A.

FIG. 5B is another side view of an example implementation of the additive manufacturing machine of FIG. 1A.

FIG. 6A is a first example diagram representative of the example method of modifying an example component implemented by the additive manufacturing machine of FIG. 1A.

FIG. 6B is a second example diagram representative of the example method of modifying an example component implemented by the additive manufacturing machine of FIG. 1A.

FIG. 6C is a third example diagram representative of the example method of modifying an example component implemented by the additive manufacturing machine of FIG. 1A.

FIG. 6D is a fourth example diagram representative of the example method of modifying an example component implemented by the additive manufacturing machine of FIG. 1A.

FIG. 6E is a fifth example diagram representative of the example method of modifying an example component implemented by the additive manufacturing machine of FIG. 1A.

FIG. 6F is a sixth example diagram representative of the example method of modifying an example component implemented by the additive manufacturing machine of FIG. 1A.

FIG. 6G is a seventh example diagram representative of the example method of modifying an example component implemented by the additive manufacturing machine of FIG. 1A.

FIG. 6H is an eighth example diagram representative of the example method of modifying an example component implemented by the additive manufacturing machine of FIG. 1A.

FIG. 6I is a ninth example diagram representative of the example method of modifying an example component implemented by the additive manufacturing machine of FIG. 1A.

FIG. 6J is a tenth example diagram representative of the example method of modifying an example component implemented by the additive manufacturing machine of FIG. 1A.

FIG. 7 is a first flowchart representative of example machine-readable instructions and/or example operations that may be executed, instantiated, and/or performed by example programmable circuitry to implement the additive manufacturing apparatus of FIG. 1A.

FIG. 8 is a second flowchart representative of example machine-readable instructions and/or example operations that may be executed, instantiated, and/or performed by example programmable circuitry to implement the additive manufacturing apparatus of FIG. 1A.

FIG. 9 is a third flowchart representative of example machine-readable instructions and/or example operations that may be executed, instantiated, and/or performed by example programmable circuitry to implement the additive manufacturing apparatus of FIG. 1A.

FIG. 10 is a fourth flowchart representative of example machine-readable instructions and/or example operations that may be executed, instantiated, and/or performed by example programmable circuitry to implement the additive manufacturing apparatus of FIG. 1A.

FIG. 11 is a block diagram of an example processing platform including programmable circuitry structured to execute, instantiate, and/or perform the example machine-readable instructions and/or perform the example operations of FIGS. 7-10 to implement the additive manufacturing apparatus of FIG. 1A.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In additive manufacturing, a component can be formed via forging and/or another additive process. As disclosed herein, “component” is defined as a part that is comprised of metal, plastic, composite, or other material. In some examples, the component can be formed by attaching parts to each other to form a final component. As described above, DED manufacturing operates by using a focused energy source to melt a feedstock material and deposit the melted feedstock material on a specified surface. DED additive manufacturing systems operate in phases, including a deposition phase, where a material is deposited to form a component, and a compression phase, where the material is compressed. The deposition phase and the compression phase typically occur sequentially.

In particular, joining, repairing, modifying, and/or building of components is performed by fusion welding. As used herein, “modification” or “modify” is defined as any change made to a prior constructed and/or modified component, including repairing the base component, fusing another component to the base component, changing of a mechanical property of the base component, and other methods of changing the base component. As used herein, “joining” is defined as the process of fusing and/or putting together a first component and a second component. As used herein, “formation,” “building,” “forging,” and/or “creation” is defined as the process of constructing a component using a feedstock material. Fusion welding is a process that uses heat to fuse two or more materials by heating them to a melting point. Fusion welding may be conducted with or without a filler (e.g., a feedstock) material. In particular, fusion welding may use heat applied via laser, electron beam, tungsten inert gas (TIG), and/or plasma. In other implementations, solid state or friction stir welding may be used to repair or join components composed of materials with a high melting point, such as nickel alloys. However, solid state welding is limited by the technical development of the materials and the design of the tools to accommodate the high temperature. Lastly, Wire Arc Additive Manufacturing (WAAM) technology is an additive manufacturing method that results in deposition of a material with the same microstructure and mechanical properties of the formerly laid down material. However, WAAM technology is not designed to join existing parts.

Notably, current solutions to modifying materials are not well suited to materials requiring high temperature or that are difficult to weld. Materials that are determined to be difficult to weld include Waspaloy®, Alloy 59, Alloy 625, Alloy 718, Alloy 939, Alloy 738, Alloy 247, etc. These materials are difficult to weld due to the probability of cracking during welding, the high temperatures required to mold the material, and the occurrence of hardening during the forging process.

Current solutions that work with difficult to weld material, such as WAAM technology, present solutions to manufacture parts from the bottom up. However, a need exists to modify and/or build components wherein the material used to modify and/or build the component is comprised of the same crystalline structure as the component. As used herein, “crystalline structure” or “microstructure” are defined to mean a three-dimensional, ordered arrangement of grains of the material and/or component, wherein the arrangement and size of the grains is substantially homogenous throughout the material. As disclosed herein, “grains” are defined as individual areas of a material with a certain size and orientation, wherein individual grains comprise a component. As used herein, “substantially” is defined as having a certain characteristic (e.g., crystalline structure, grain size, etc.) through a majority of the material and/or component. Further, material, like Waspaloy®, is difficult to fusion weld and welded joints present significant changes to material properties of the component. Fusion welding produces a microstructure like casting; however, the microstructure of a cast material is different from the original component. Furthermore, while solid-state welding for non-axisymmetric geometries (like friction stir welding) is available for materials with high melting points (e.g., some nickel alloys), solid-state welding is limited by the development of tool material and tool design to withstand the high temperatures. Therefore, a solution is needed to modify and/or build components in which the material used to modify and/or build the component is comprised of the same crystalline structure as the original component after the process is completed.

While the above described additive manufacturing process can be used to form a component (e.g., join a component from various parts, etc.), modification and/or repair of a component may be advantageous in situations where cracks or other deformations have arisen in the original component. To modify a component, the feedstock material is deposited in the area of the deformation. Modification of a component is difficult where the component and the feedstock material have different crystalline structures. The difference in the crystalline structures can lead to different material properties, such as response to applied pressure and temperature, which can impact performance of the repaired and/or modified component. Therefore, modifying a component so that the repaired area has the same crystalline structure as the original component is advantageous to overall performance.

Modification of a component so that the modified area has the same crystalline structure as the original component is difficult. In particular, deposited material (e.g., metal, plastic, composite, etc.) has physical and/or material properties, such as grain size, which impacts a resulting part formed from an AM process. Grain size is an important feature in AM components because the grain size affects the mechanical properties and ultimate performance of the component. Therefore, when modifying the component, it is important that the grain size be suited to the use of the original component to protect against cracking and other deformities due to the differing mechanical properties of the materials. Generally, the finer the grain size, the better the strength/fatigue properties of the part, and the coarser the grain size, the better the performance against creep (e.g., deformation of material under stress and temperature) and other stress. Parts subject to lower operating temperatures generally have finer grain sizes to increase strength/fatigue properties, while parts subject to higher operating temperatures generally have coarser grain size for better creep performance. Due to differing grain sizes during the AM process, parts are often formed with a compromise between strength/fatigue properties and creep performance, which reduces overall performance of the part.

Disclosed herein is a method to create, form, repair, and/or otherwise modify a base component by a welding (e.g., melting) process accomplished with or without a filler material and using a local forging technique in a bead region. As disclosed herein, the “bead region” is defined as an area on the component where the AM process is performed. The method to create, form, repair, and/or otherwise modify the component includes deforming procedures to reduce the probability of cracks upon later deposition of a layer of material (e.g., Waspaloy®, nickel-based alloys, etc.). The bead region may be formed by melting the base component to fuse portions of the base component to itself or by the addition of filler material. As disclosed herein, the additive forging method utilizes induced strain and temperature control to produce a material with a fully recrystallized microstructure in the bead region with the same microstructure and material properties as the base component. As used herein, a “fully recrystallized microstructure” is defined as a microstructure that has undergone static recrystallization throughout an area of a bead region and/or deposited material.

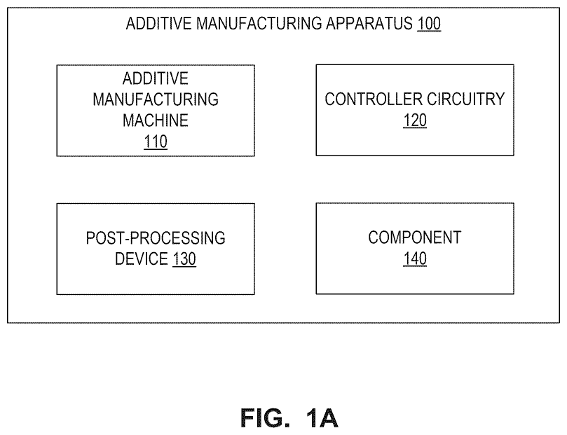

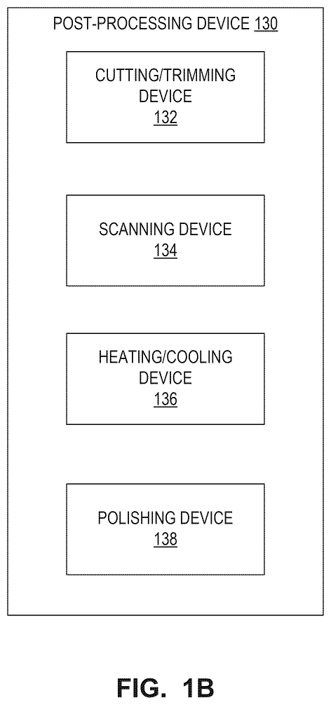

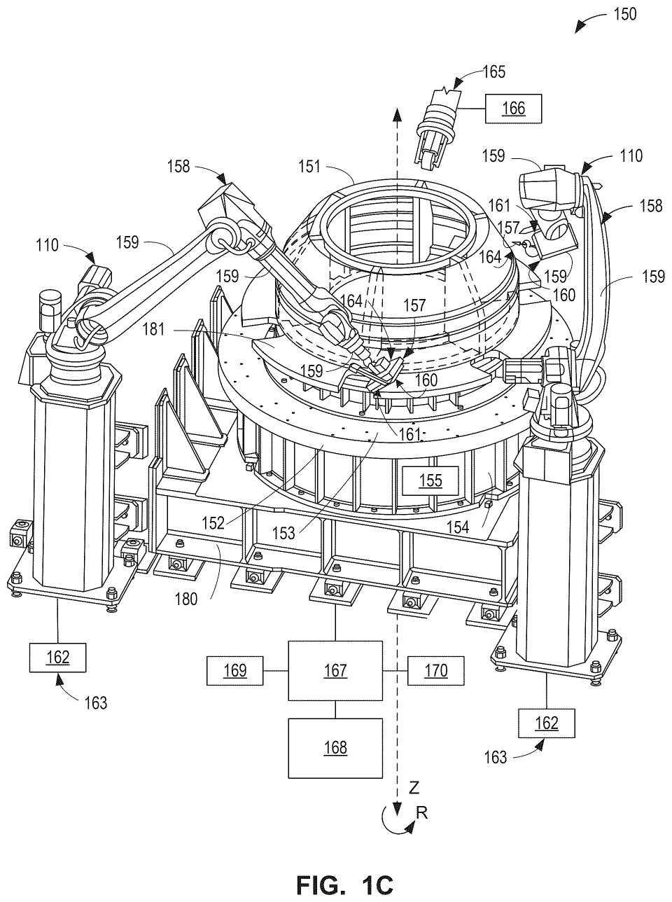

FIG. 1A is a block diagram of an example additive manufacturing infrastructure or apparatus 100. The example additive manufacturing apparatus 100 includes an example additive manufacturing machine 110, example controller circuitry 120, an example post-processing device 130, and an example component 140 (also referred to herein as a part). The additive manufacturing machine 110 includes a device for depositing and/or melting an additive material to create, form, repair, and/or otherwise modify the example component 140. The component 140 can be any 3D structure. In some examples, the additive manufacturing machine 110 can utilize directed energy deposition (DED) to deposit a wire of additive material that is heated and moldable, allowing the additive manufacturing machine 110 to control the deposition of the material in wire form to build and/or modify the component 140. In some examples, the additive manufacturing machine 110 can utilize Direct Metal Laser Melting (DMLM), or any other form of laser melting process, to heat a metal powder into a melt pool that is then formed into the example component 140. The additive material may consist of any material that can be used during the AM process, such as steel, titanium, aluminum, alloys of many combinations, etc., and may come in the form of a wire or a powder, for example.

The controller circuitry 120 of the additive manufacturing apparatus 100 of FIG. 1A includes computer readable instructions to create, form, repair, and/or otherwise modify the component 140 based on a computer model. The controller circuitry 120 of FIG. 1A can be instantiated (e.g., creating an instance of, bring into being for any length of time, materialize, implement, etc.) by processor circuitry such as a central processing unit executing instructions. Additionally, or alternatively, the controller circuitry 120 of FIG. 1A can be instantiated (e.g., creating an instance of, bring into being for any length of time, materialize, implement, etc.) by an application specific integrated circuit (ASIC) or a field programmable gate array (FPGA) structured to perform operations corresponding to the instructions. It should be understood that some or all of the circuitry of FIG. 1A may, thus, be instantiated at the same or different times. Some or all of the circuitry can be instantiated, for example, in one or more threads executing concurrently on hardware and/or in series on hardware. Moreover, in some examples, some or all of the circuitry of FIG. 1A can be implemented by microprocessor circuitry executing instructions to implement one or more virtual machines and/or containers.

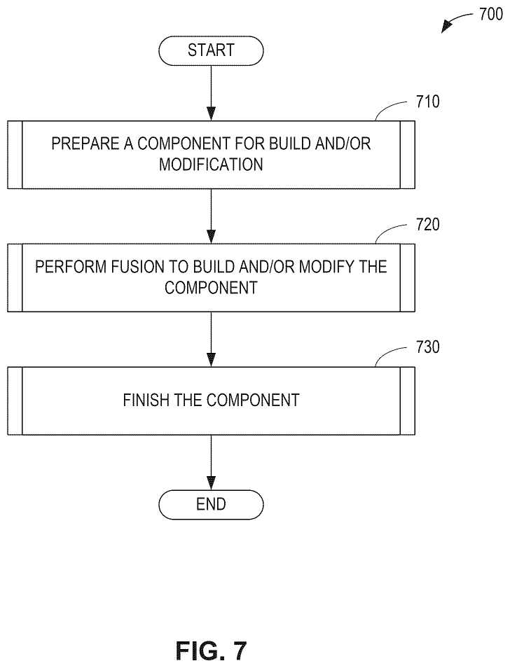

The controller circuitry 120 of the illustrated example of FIG. 1A instructs the additive manufacturing machine 110 to build and/or modify the component 140 based on a computer model and/or other schematic, instruction, configuration, etc. In some examples, the controller circuitry 120 is instantiated by processor circuitry executing example controller instructions and/or configured to perform operations such as those represented by the flowchart of FIGS. 7-10 to build and/or modify the component 140. Further, in some examples, the controller circuitry 120 instructs the additive manufacturing machine 110 to build and/or modify the component 140 based on user input and user control of the additive manufacturing machine 110 via a user interface.

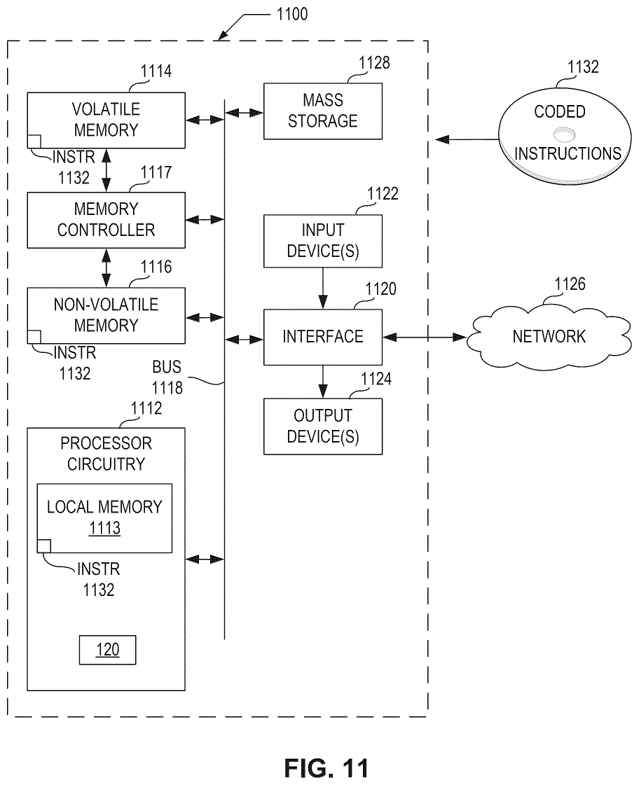

In some examples, the additive manufacturing apparatus 100 includes means for building and/or modifying the component 140 based on a computer model. For example, the means for building and/or modifying the component 140 based on a computer model can be implemented by the controller circuitry 120. In some examples, the controller circuitry 120 can be instantiated by processor circuitry such as the example programmable circuitry 1112 of FIG. 11.

In some examples, the means for building the component 140 based on a computer model includes means for modifying the component 140. For example, the means for modifying the component 140 to modify the component 140 with the same crystalline structure as the base material can be implemented by the controller circuitry 120. In some examples, the controller circuitry 120 can be instantiated by processor circuitry such as the example programmable circuitry 1112 of FIG. 11.

In some examples, the means for building also includes means for instructing the additive manufacturing machine 110 to build and/or modify the component 140 based on the computer model. For example, the means for instructing the additive manufacturing machine 110 to build and/or modify the component 140 can be implemented by the controller circuitry 120. In some examples, the controller circuitry 120 can be instantiated by processor circuitry such as the example programmable circuitry 1112 of FIG. 11.

FIG. 1B is a block diagram of an example post-processing device 130. The post-processing device 130 can include an example cutting/trimming device 132, an example scanning device 134, an example heating/cooling device 136, and an example polishing device 138. In some examples, additional devices may be included in the post-processing device 130 to complete the formation of the component 140. In some examples, after the component 140 has been built, post-processing is applied to finalize the component 140 for output and use (e.g., a fan case for an engine, a blade, other shroud, shell, or casing, etc.). Such post-processing can be performed by the post-processing device 130.

In some examples, the additive manufacturing apparatus 100 includes means for post-processing the component 140 prior to outputting the component 140 for use. For example, the means for post-processing can be implemented by the post-processing device 130. In some examples, the post-processing device 130 can be a separate machine/component that may post-process the component 140.

The cutting/trimming device 132 of the illustrated example of FIG. 1B trims away excess additive material from the component 140 produced by the additive manufacturing machine 110. In some examples, the additive manufacturing machine 110 leaves excess additive material (e.g., structural support to lay/melt a layer of additive material, extra material from deposition of filler material or fusion in the bead region) that is not desired for the final component 140. In such an example, the excess additive material is to be trimmed/cut off to transform the component 140 into the usable, final component 140.

In some examples, the post-processing device 130 implements means for trimming and/or cutting away excess material from the component 140. The means for trimming and/or cutting away excess material can be implemented by the cutting/trimming device 132.

The scanning device 134 of the illustrated example of FIG. 1B scans the component 140 for structural deficiencies and/or build errors. In some examples, the additive manufacturing machine 110 can produce insufficient structural components and/or fail in the modification process. In such an example, the scanning device 134 can scan the component 140 (using scanners, optical devices, sensors, etc.) for those insufficient structural components and/or errors. The result of the scan can include an output to an operator and/or the computer model that the structural inefficiencies and/or errors exist such that intervention, rebuilding, another form of post-processing, etc., is warranted.

In some examples, the post-processing device 130 implements means for scanning the component 140 for deficiencies and/or build errors. The means for scanning the component 140 for deficiencies and/or errors can be implemented by the scanning device 134.

The heating/cooling device 136 of the illustrated example of FIG. 1B subjects the component 140 to an additional heat source and/or subjects the component 140 to a quenching process/cooling source once the build is complete. In some examples, an additional heat treatment process can reinforce the component's 140 structural integrity (e.g., reinforcing strength/fatigue performance). In some examples, a cooling source can cool the component 140 once the build is complete. In other examples, the component 140 may be subjected to both the heat source and the cooling source once the AM process is complete.

In some examples, the post-processing device 130 implements means for heating and/or cooling the component 140. The means for heating and/or cooling the component 140 can be implemented by the heating/cooling device 136.

The polishing device 138 of the illustrated example of FIG. 1B polishes the component 140 to create a smooth surface for the final component 140. In some examples, the additive manufacturing machine 110 creates rough/uneven edges around the surface of the component 140 that are unsuitable for deployment and use of the final component 140 in its desired application. In such an example, the polishing device 138 can smooth the surface of the component 140 such that the final component 140 is suitable for use.

In some examples, the post-processing device 130 implements means for polishing the component 140. The means for polishing the component 140 can be implemented by the polishing device 138.

Any one of or any combination of the cutting/trimming device 132, the scanning device 134, the heating/cooling device 136, and the polishing device 138 can be used by the post-processing device 130. Additionally, or alternatively, any form of post-processing to finalize and output a fully functional component 140 may be used interchangeably herein.

FIG. 1C illustrates an example DED additive manufacturing system 150 (hereinafter, the system 150). The system 150 is configured to build and/or modify the component 151 using feedstock material. In other examples, the system 150 is configured to build and/or modify the component 151 without using feedstock material. In the illustrated example of FIG. 1C, the component 151 is a cylindrically shaped component, but in other examples, the component 151 may have a different geometry.

As illustrated in the example of FIG. 1C, the system 150 includes an example build table 152. At least a portion of the build table 152 is configured to rotate about a vertical axis Z of the build table 152, which rotates the component 151 supported on the build table 152. Thus, the build table 152 is a rotary build table. In particular, the build table 152 defines an example build surface 153 on which the component 151 is built and supported. Here, the build surface 153 is oriented in the X-Y plane and is a horizontal build surface, but the build surface 153 may have other orientations. In the illustrated example, the build table 152 is disposed on an example base 154. The base 154 may include an example actuator 155 that moves (rotates) the build table 152 about the vertical axis Z in a clockwise or counterclockwise rotation direction. In the illustrated example, the actuator 155 rotates the build table 152 in a counterclockwise direction R about the vertical axis Z. Also, as hereinafter described, the actuator 155 rotates the build table 152 at a variable rotation speed. In some examples, the base 154 is further configured to move (translate) the build table 152 vertically along the vertical axis Z (e.g., in the Z-dimension depicted in FIG. 1C).

In the illustrated example of FIG. 1C, an example pallet 181 is provided on the build surface 153 of the build table 152, and the component 151 is built on the pallet 181. As such, upon completion of manufacturing the component 151, a forklift or other material handling equipment may be utilized to engage the pallet 181 and remove the component 151 from the build table 152. When utilized, the pallet 181 may be selectively secured to the build table 152, for example, with mechanical fasteners and/or a locking system.

The system 150 also includes the additive manufacturing machine 110. The additive manufacturing machine 110 has example deposition heads 157 through which a stream of feedstock material may be deposited to build and/or modify the component 151. In the illustrated example of FIG. 1C, two deposition heads 157 are depicted, but, in other implementations, one deposition head or more than two deposition heads may be implemented to perform the function of the deposition heads 157. As described herein, the feedstock material is melted and output from the deposition heads 157, as a stream of melted feedstock material, at a deposition rate. In some examples, the deposition rate may vary. The deposition rate may vary to deposit a greater or lesser quantity of feedstock material in certain regions of the component 140. The quantity of feedstock material deposited in a certain region of the component 140 may be based on the application of the component 140, the desired configuration of the component 140, and/or the desired material properties for that region of the component 140. The additive manufacturing machine 110 includes a support that adjustably and movably supports the deposition heads 157. In the illustrated example, the support is implemented by example robotic arms 158 including a plurality of example links 159 that may articulate relative to each other to adjust the position of the deposition heads 157, which are supported on an example distal most link 160 of the plurality of links 159. In the illustrated example of FIG. 1C, two robotic arms 158 are depicted, but, in other implementations, one robotic arm or more than two robotic arms may be implemented to perform the function of the robotic arms 158.

Accordingly, it should be understood that the deposition heads 157 and the build table 152 are movable relative to each other. For example, the robotic arms 158 may include one or more actuators (not shown in the view of FIG. 1C) that rotate the links 159, 160 of the robotic arms 158 relative to one another to move the robotic arms 158 and the deposition heads 157 supported thereon relative to the build table 152. It will be appreciated that the robotic arms 158 may have various other configurations for moving and adjusting the position of the deposition heads 157 in multiple degrees of freedom without departing from the present disclosure.

The additive manufacturing machine 110 includes energy sources 161 and material sources 162. The material sources 162 are configured to convey the feedstock material to the deposition heads 157 where the feedstock material is deposited on the build table 152. In some examples, the material sources 162 are a material spool and feeder system configured to convey example filament or wire 163 (e.g., a metal or polymer-based wire) to the deposition heads 157. Thus, the material sources 162 may house the wires 163 that are fed to the deposition heads 157. For example, the wires 163 may be routed externally of the robotic arms 158 to the deposition heads 157 or through an internal cavity of the robotic arms 158 that connects to the deposition heads 157. In other examples, rather than being a material spool and feeder system configured to convey the wires 163, the material sources 162 may include a pressurized powder source that conveys a pressurized stream of powder feedstock material to one or more material delivery devices (e.g., nozzles, valves, or the like) of the deposition heads 157. Any suitable feedstock material capable of being used in DED processes may be used consistent with the present disclosure. Further, in other examples, feedstock material is not used to repair or modify the component 151. Instead, in some such examples, heat and compression are applied without the deposition of feedstock material by the deposition heads 157.

The energy sources 161 may take various forms depending on the implementation. In the illustrated example, the energy sources 161 are plasma transferred arc heat sources. In other examples, the energy sources 161 may include laser sources and optics configured to direct a laser beam having a desired energy density to the build surface 153 of the build table 152. In some examples, the energy sources 161 may include an electron emitter connected to a power supply and at least one focusing coil configured to direct an electron beam to the component 151 being constructed on the build surface 153 of the build table 152. In such examples, the build table 152 may be placed in a build chamber (not depicted) under a vacuum or having an oxygen-reduced environment. However, the energy sources 161 may take various other forms, such as a plasma source, an electron beam source, a thermal energy source, etc. In some examples, the energy sources 161 may comprise multiple energy sources, such as a laser source and a plasma transferred arc.

It should be understood that the system 150 may include any number of energy sources and material sources in accordance with the present disclosure. Additionally, feedstock material from the material sources 162 may be routed to the deposition heads 157 in various ways for emission onto the build table 152. For example, in some examples, the wires 163 from the material source 162 may be divided into two or more material feeds that are routed through the robotic arms 158 into the deposition heads 157. Each material feed may exit the deposition heads 157 at a separate delivery nozzle as a material stream.

In operation, one or more streams of feedstock material are fed into a path of an energy beam from the energy sources 161 and emitted by the deposition heads 157 as a stream of melted feedstock material. In particular, at points of overlap between the energy beam and the stream(s) of feedstock material where the energy beam possesses the requisite energy density, the energy may heat the feedstock material to a sufficient extent to form example bead regions 164 (e.g., melt pools) on the build surface 153. Melted feedstock material may continuously be fed through and deposited from the deposition heads 157 such that the bead regions 164 form a pattern corresponding to the movement pattern of the deposition heads 157 and the build table 152. Movements of the deposition heads 157 and the build table 152 may be determined based on a desired modification of the component 151 such that, as the bead regions 164 cool, the feedstock material hardens to form a portion of the component 151. Accordingly, in some examples, the rotation speed of the build table 152 may be manipulated so that filler material is deposited in certain areas in greater and/or lesser amounts. Further, in some examples, the rotation speed of the build table 152 may be manipulated so that the component 140 is compressed when the previously deposited material is hotter and/or cooler. In this example, rotation of the build table 152 about the vertical axis Z as the deposition head 157 deposits the bead regions 164 results in building or modification of the component 151 based on the desired operation by the user. In this example, the deposition heads 157 deposit the bead regions 164 along the Z axis to fuse a first component of the component 151 to an adjacent second component of the component 151. As used herein, “adjacent” is defined to mean that a first edge of a first component is in contact with a second edge of a second component. Therefore, as the build table 152 rotates, the circular shaped component 151 is formed by a plurality of component parts fused together along the Z axis. In other examples, rotation of the build table 152 about the vertical axis Z as the deposition head 157 deposits the bead regions 164 result in a circular shaped stream of melted feedstock material that, as the build table 152 continuously rotates over time, results in fusion of component parts along an axis perpendicular to the Z axis. Also, the robotic arms 158 may position the deposition heads 157 radially towards or away from the vertical axis Z to create a non-circular shaped component with a varying size and diameter as illustrated. Further, the robotic arms 158 may position the deposition heads 157 at any orientation relative to the build table 152 and the Z axis to modify the component 151.

The system 150 further includes an example roller 165. The roller 165 is positioned proximate to the additive manufacturing machine 110 and operable to continuously apply a force to the deposited feedstock material which forms the component 151. As described herein, the roller 165 is configured to apply a force to the component 151 during (or simultaneously with) a deposition phase where the additive manufacturing machine 110 is depositing the stream of melted feedstock material to build and/or modify the component 151, such that the roller 165 may apply a force to a portion of the deposited stream of melted feedstock material that is downstream of the additive manufacturing machine 110 while the additive manufacturing machine 110 continues to deposit the stream of melted feedstock material. In this example, the roller 165 includes at least one actuator and an example load source 166. In the illustrated example of FIG. 1C, the system 150 includes one roller 165, but in other implementations covered by this disclosure the system 150 may include more than one roller 165 to carry out the function of the roller 165 as described herein.

Generally, the at least one actuator is configured to move and manipulate the orientation of the load source 166 relative to the portion of the component 151 to which the compressive load is to be applied. The load source 166 applies a force to the deposited material to introduce the required strain level in the deposited layer and/or improve mechanical properties of the component 151, for example, grain refinement and recrystallization.

As described herein, the robotic arms 158 are operable to position the deposition heads 157 in close proximity of the load source 166 and/or the roller 165 is operable to position the load source 166 in close proximity of the deposition heads 157. The distance between the load source 166 and the deposition heads 157 may be increased if cold rolling is intended, for example, by rotating the build table 152 in an opposite clockwise direction. By rotating the build table 152, it is possible to operate the deposition heads 157 to deposit melted feedstock material in the bead regions 164 while the load source 166 applies the compressive load to the component 151, with the load source 166 trailing the deposition heads 157 such that the load source 166 applies the load to previously deposited material a short time after deposition depending on the rotation speed of the build table 152. Thus, the roller 165 may apply a compressive load to the component 151 at the same time as the deposition heads 157 are creating the bead regions 164, at least in close proximity to the bead regions 164 of the component 151. Not only does this decrease machine cycle time, but also allows the compressive load to be applied to the component 151 at a constant temperature and at a temperature suitable to provide the component 151 with forge-like qualities.

A grain refinement mechanism responsible for the forge-like properties, as shown in FIG. 1C, may be utilized to provide static or dynamic recrystallization. Dynamic recrystallization occurs during deformation of a material. Static recrystallization occurs upon subsequent annealing of a deformed material. It should be appreciated that cold rolling can produce static recrystallization when the material is first strained at an ambient temperature and then re-heated with a consequent grain refinement. The re-heat in DED is provided by the most recent layer deposition to the layer(s) below.

In some examples, the system may further include an example controller 167. The controller 167 may be communicatively coupled to the build table 152, the additive manufacturing machine 110, the roller 165, and/or the material sources 162. Thus, the controller may be in communication with the base 154, the robotic arms 158, and/or the roller 165 to control operation of the same. For example, the controller 167 may include a processor and memory storing computer readable instructions which, when executed by the processor, dynamically controls rotation direction and/or rotation speed of the build table 152 about the vertical axis Z, vertical translation of the build table 152 along the vertical axis Z, position and orientation of the deposition heads 157 in space via the robotic arms 158, position and orientation of the load source 166 in space, and/or the magnitude of compressive load applied by the load source 166. The controller 167 may also be configured to control the feed rate at which the material sources 162 feeds or supplies the feedstock material to the deposition heads 157 and/or control the deposition rate at which the stream of melted feedstock material is output from the deposition heads 157.

In some examples, the system 150 may have various sensors communicatively coupled to the controller 167, and the controller 167 may utilize data communicated from the various sensors to control operation of the build table 152, the additive manufacturing machine 110, the roller 165, and/or the material source 162 as may be desired for modifying the component 151. In some examples, an example sensor system 168 may scan the component 151 to measure the dimensions of the component 151 as it is being modified. For example, lasers or cameras could be utilized to monitor the geometry of the component 151 and control the orientation of the additive manufacturing machine 110 and/or the roller 165 based on that sensed data.

In some examples, the system 150 includes one or more example temperature sensors 169 and/or one or more example stress sensors 170. The temperature sensor 169 may be configured to measure a surface temperature of the layer of feedstock material deposited via the deposition heads 157 inside and/or outside of the bead regions 164. In some examples, the temperature sensor 169 may include at least one pyrometer or thermal camera configured to check the actual surface temperature of the deposited feedstock material. The temperature sensor 169 is communicably coupled to the controller 167 (e.g., associated with a remainder of the system 150) which includes control logic that evaluates the measurements of the temperature sensor 169. In some examples, the controller 167 is configured to determine when a temperature of the deposited layer of feedstock material is suitable for a counterbalancing treatment via the load source 166. For example, a suitable temperature range for compressive load treatments may be determined based on material properties (e.g., plasticity, coefficient of thermal expansion, and the like) associated with the feedstock material deposited via the deposition heads 157.

In some examples, the controller 167 is configured to determine when a temperature of the deposited layer of feedstock material is suitable for recrystallization by layering with feedstock material at a measured temperature. In some examples, the controller 167 is configured to control relative position between the deposition heads 157 and the load source 166 based on the measurements of the temperature sensor 169. For example, the controller 167 can cause movement of the deposition heads 157 nearer or farther from the load source 166 to ensure that the compressive load is being applied to material having a desired constant temperature. When a measurement of the temperature sensor 169 indicates that a previously deposited feedstock material is not suitable for compression or not uniform with previously compressed feedstock material, the controller 167 can transmit control signals to the actuator 155 of the build table 152 to vary rotation speed and/or transmit control signals to the robotic arms 158 to adjust a positioning of the deposition heads 157.

In some examples, the stress sensor 170 (e.g., strain sensor) can be configured to measure a residual stress in the layer of feedstock material after the compression treatments are performed via the load source 166. The stress sensor 170 (e.g., strain sensor) is communicably coupled to the controller 167 (e.g., associated with a remainder of the system 150) which includes control logic that evaluates the readings of the stress sensor 170 (e.g., strain sensor). The stress sensor 170 (e.g., strain sensor) can include an ultrasonic stress sensor or the like. In some examples, the controller 167 can be configured to determine if the stress/strain measurements obtained via the stress sensor 170 (e.g., strain sensor) are within an acceptable threshold to ensure high build quality (e.g., strain within a range of 5-30%). When the measurements are outside of the threshold, the controller 167 can modify various parameters of the build process. In some examples, when an unacceptable amount of residual stress is detected, the controller 167 can modify operation of the roller 165 (e.g., by modifying the load application parameters such as force magnitude, and the like) to correct for the residual stress in the component 151 being outside of an acceptable threshold, wherein residual stress can be the combination of thermal stress given by the cooling after deposition and the mechanical stress caused by compression. In some examples, when an unacceptable amount of residual stress is detected, the controller 167 can modify various operating parameters associated with the deposition heads 157 (e.g., energy beam power, movement speed, material feed rate) to reduce residual stress in the component 151.

In the illustrated example of FIG. 1C, the deposition heads 157 deposit feedstock material to modify the component 151 on the build table 152 while the build table 152 rotates in the counterclockwise direction R about the vertical axis Z and, as the build table 152 continues to rotate the component 151 in the counterclockwise direction R, the feedstock material previously deposited by the deposition heads 157 will encounter the load source 166 after being deposited from the deposition heads 157. Thus, in the illustrated example, the deposition head 157 acts on a particular portion of the component 151 before the load source 166 acts on that particular portion of the component and, similarly, the load source 166 acts on a particular portion of the component 151 after the deposition head 157 has acted on that particular portion of the component 151. Stated differently, because the build table 152 rotates in the counterclockwise direction R in the illustrated embodiment, the deposition head 157 is positioned before (or upstream of) the load source 166 and the load source 166 is positioned after (or downstream of) the deposition head 157. In some examples, the temperature sensor 169 can be positioned before the load source 166 to help ensure that the mechanical load is applied at the correct temperature and the stress sensor 170 may be positioned after the load source 166 to determine if the resulting stress is at a desired level (e.g., near zero for a stress-relieving treatment or a negative value if a counterbalancing treatment is being performed to promote grain refinement). In some examples, the temperature sensor 169 is provided on the additive manufacturing machine 110, for example, proximate the deposition heads 157, to accurately measure temperature of the melted feedstock material being deposited therefrom. In some examples, the temperature sensor 169 is provided proximate the load source 166 in addition to or in lieu of the temperature sensor 169 placed proximate the deposition head 157.

By monitoring the surface temperature of the component 151 in close proximity of the load source 166, the system 150 is able to help ensure application of a compressive load to portions of the component 151 when the previously deposited material is at a certain temperature. In some examples, the temperature for recrystallization for a nickel-based superalloy is about 400° C. In this example, while a portion of the component 151 is being compressed, feedstock material is deposited by the deposition heads 157 on the component 151 before traversal by the roller 165.

In the illustrated example, the system 150 further includes a platform 180 on which the other components of the system 150 are mounted. It should be appreciated, however, that a platform 180 is not required, and one or more of the other components of the system 150 may be secured to the ground surface or floor.

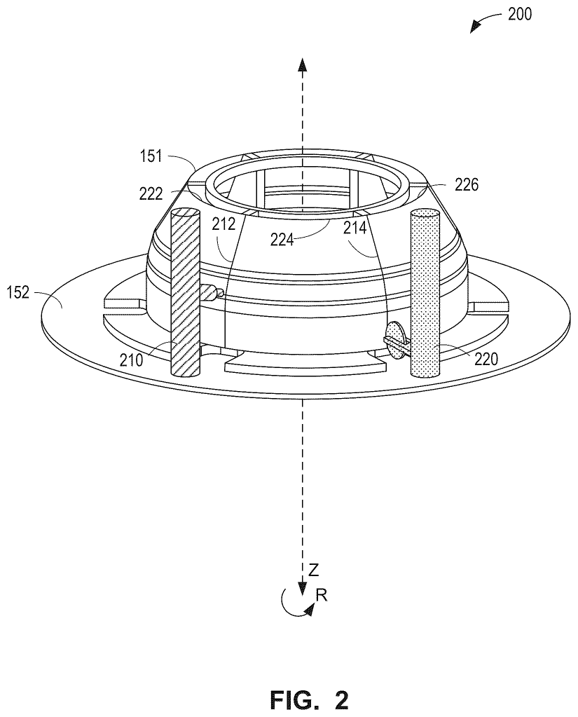

FIG. 2 shows an environment 200 using the system 150 to perform an example longitudinal weld on the component 151. In the environment 200, an example additive manufacturing machine 210 acts on the component 151 in a longitudinal direction. In this example, the build tables 152 rotates the component 151 in the counterclockwise direction R about the Z axis. In the illustrated example of FIG. 2, the additive manufacturing machine 210 performs fusion welding to form a bead region 212 between adjacent sections 222, 224 of the component 151. In this example, the additive manufacturing machine 210 welds the adjacent sections 222, 224 while an example roller 220 compresses a previously formed bead region 214 between the adjacent sections 224, 226. Therefore, the build table 152 rotates the component 151 in the counterclockwise direction so that after the additive manufacturing machine 210 deposits the bead region 212 the roller 220 compresses the bead region 212. In other words, the build table 152 rotates the component 151 so that the additive manufacturing machine 210 deposits the bead region 212 that is then compressed by the roller 220. Further, in some examples, the build table 152 continues to rotate the component 151 so that the additive manufacturing machine 210 deposits another layer of material on the previously compressed region. In some examples, the build table 152 does not rotate the component 151 and, instead, robotic arms and/or positioning mechanisms can position the additive manufacturing machine 210 and the roller 220 to act on the adjacent sections of the component 151 in sequence.

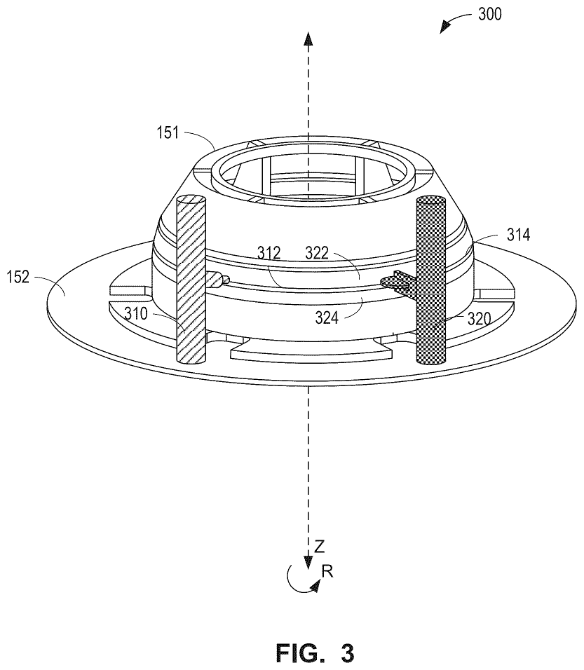

FIG. 3 shows an environment 300 using the system 150 to perform an example circumferential weld on the component 151. In the environment 300, an example additive manufacturing machine 310 acts on the component 151 in a circumferential direction. Then, in this example, the build table 152 rotates the component 151 in the counterclockwise direction R about the Z axis. In the illustrated example of FIG. 3, the additive manufacturing machine 310 performs fusion welding to form a bead region 312 between adjacent sections 322, 324 of the component 151. In this example, the additive manufacturing machine 310 welds the adjacent sections 322, 324 while an example roller 320 compresses a previously formed bead region 314. Therefore, the build table 152 rotates the component 151 in the counterclockwise direction so that after the additive manufacturing machine 310 deposits the bead region 312, the roller 320 compresses the bead region 312. The build table 152 rotates the component 151 so that the additive manufacturing machine 310 deposits the bead region 312 that is then compressed by the roller 320. Further, in some examples, the build table 152 continues to rotate the component 151 so that the additive manufacturing machine 310 deposits another layer of material on the previously compressed region. In some examples, the build table 152 does not rotate the component 151 and, instead, robotic arms and/or other positioning mechanisms position the additive manufacturing machine 310 and the roller 320 to act on the adjacent sections of the component 151 in sequence.

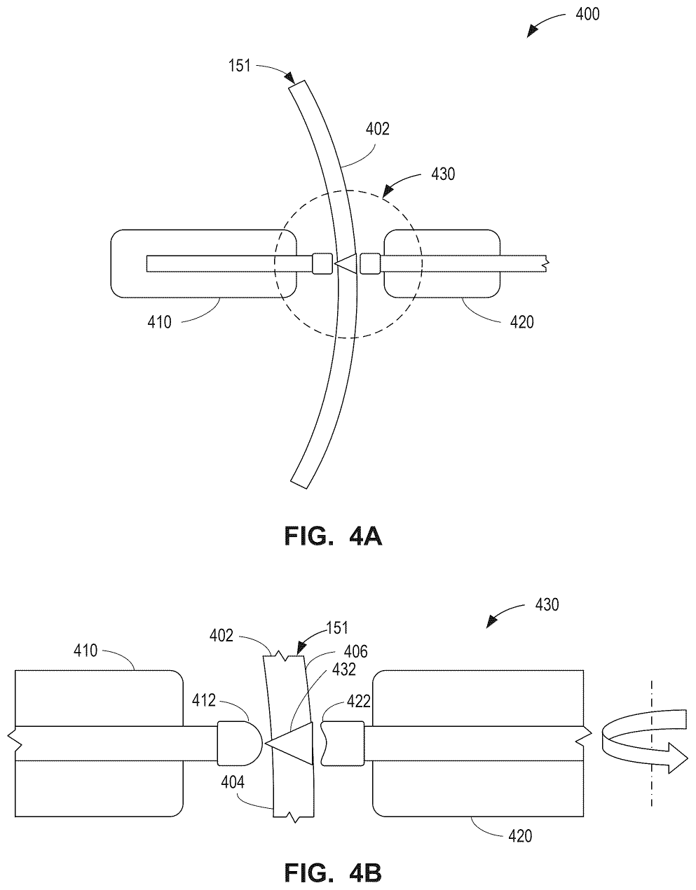

FIG. 4A is a diagram of a top-view of an example configuration 400 of the system 150 including an implementation of the roller 165. In this example, a part 402 of the component 151 is located between an inner roller 410 and an outer roller 420. Further, in this example, the additive manufacturing machine 110 previously deposited a material to build and/or modify the part 402. In this example, the inner roller 410 is located on the interior of the component 151, and the outer roller 420 is located on the outside of the component 151. In the illustrated example of FIG. 4A, a callout 430 includes the compression of a bead region 432 of the part 402 between the inner roller 410 and the outer roller 420.

FIG. 4B is a close-up view of the callout 430 of FIG. 4A. In the illustrated example of FIG. 4B, the bead region 432 on the part 402 is located between the inner roller 410 and the outer roller 420. Further, a first end 412 of the inner roller 410 contacts the bead region 432 on the interior surface 404 of the part 402. Accordingly, a second end 422 of the outer roller 420 contacts the bead region 432 on the exterior surface 406 of the part 402. In this example, the first end 412 of the inner roller 410 is a convex shape, and the second end 422 of the outer roller 420 is a concave shape. The first end 412 of the inner roller 410 and the second end 422 of the outer roller 420 are shaped to mold the bead region 432 with a rounded edge towards the exterior of the component 151 (e.g., with a rounded edge towards the exterior surface 406 of the part 402). In other examples, the first end 412 of the inner roller 410 and the second end 422 of the outer roller 420 are shaped so that the inner roller 410 is concave and the outer roller 420 is convex, or are otherwise shaped (e.g., with straight edges, triangular, etc.). After the bead region 432 of the part 402 is compressed between the first end 412 of the inner roller 410 and the second end 422 of the outer roller 420, the bead region 432 is shaped to the desired preference of the user.

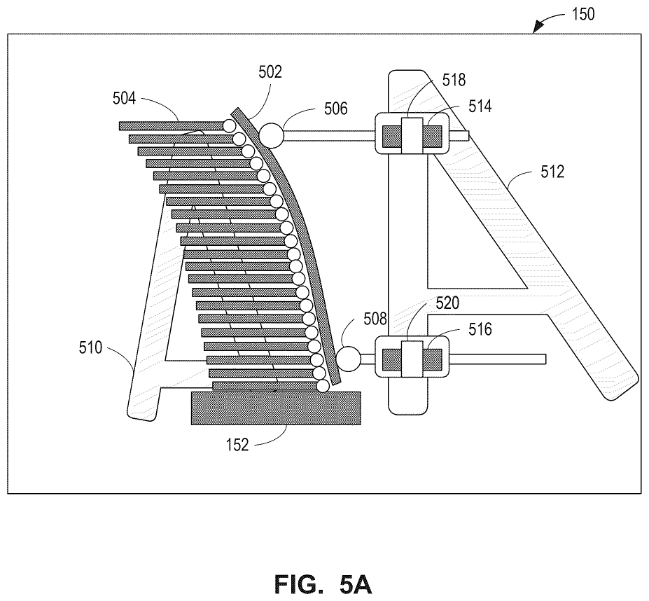

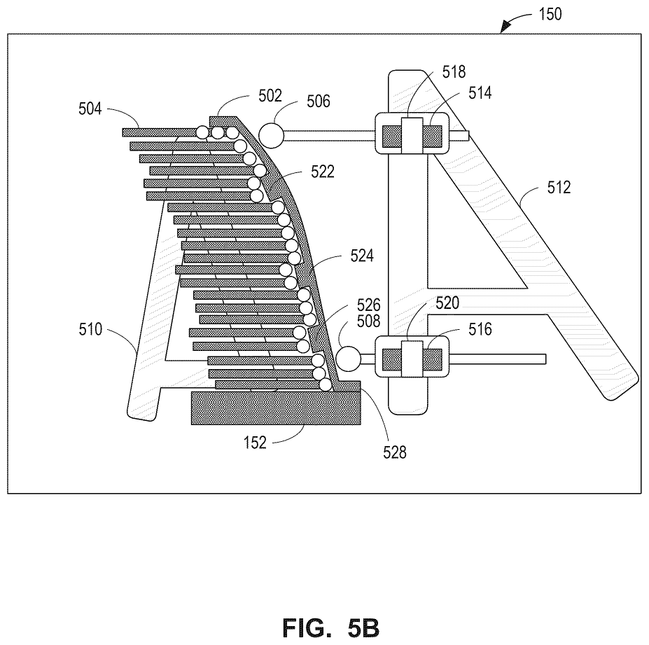

FIG. 5A is a side view of an example configuration of the system 150 including the roller 165. In the illustrated example of FIG. 5A, a part 502 is compressed between a set of inner rollers 504 and a set of outer rollers 506, 508. Further, example load structures 510, 512 house the inner rollers 504 and the outer rollers 506, 508, respectively. In this example, the load structure 510 rests on the build table 152 and is positioned to support an interior of the part 502. In this example, the load structure 512 includes actuators 514, 516 to trigger load cells 518, 520, respectively. Once the actuators 514, 516 trigger the load cells 518, 520, the load cells 518, 520 operate the outer rollers 506, 508 to compress the part 502. The actuators 514, 516 can be electric, mechanical, pneumatic, or otherwise powered. In some examples, the load structures 510, 512 can be adjustable load carrying structures that apply differential pressure depending on the properties of the part 502, the feedstock material, and other characteristics of the build and/or modification of the part 502. Further, the load structures 510, 512 can include at least one of an adjustable load carrying structure, a slotted segment, an actuator, a load cell, and/or a roller.

FIG. 5B is another side view of an example configuration of the system 150 including the roller 165. In this example, the part 502 is repaired so that the additive manufacturing machine 110 deposited material at positions 522, 524, 526 along the part 502. Further, in this example, the part 502 is fixed to the surface of the build table 152 at a position 528. In this example, the inner rollers 504 support the positions 522, 524, 526 to compensate for the deposited material and enable compression between the inner rollers 504 and the outer rollers 506, 508.

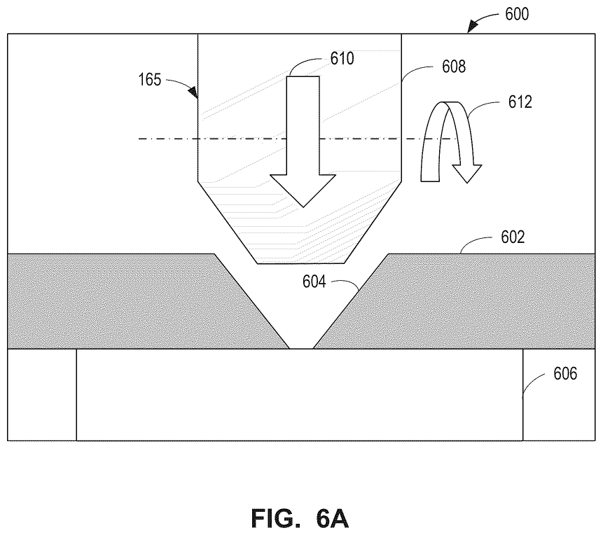

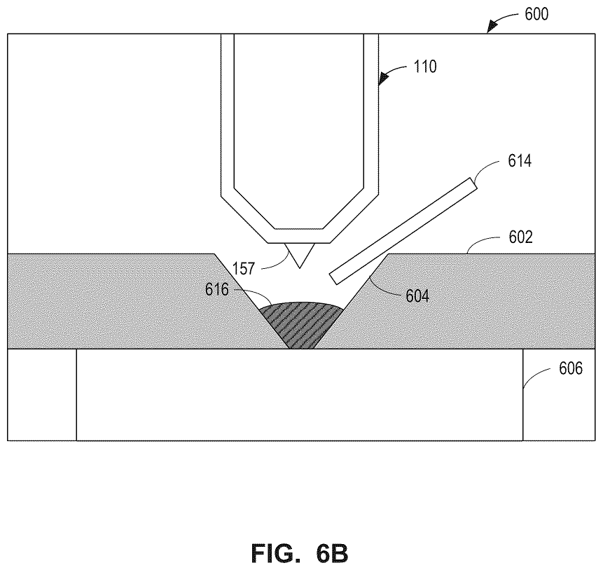

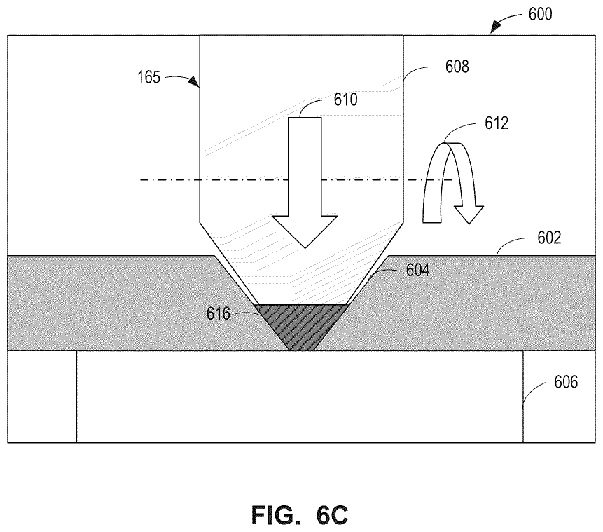

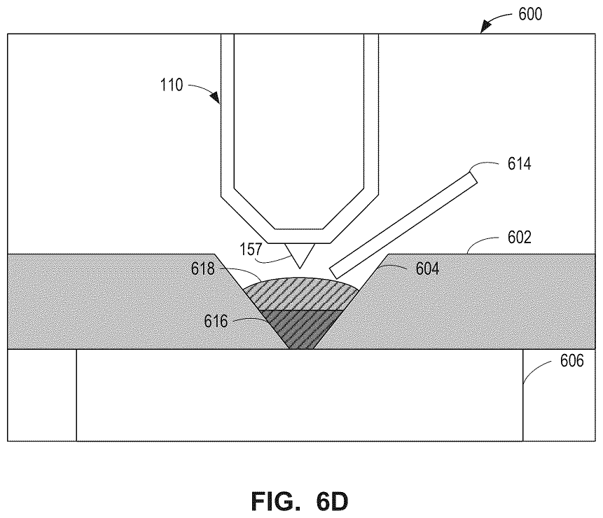

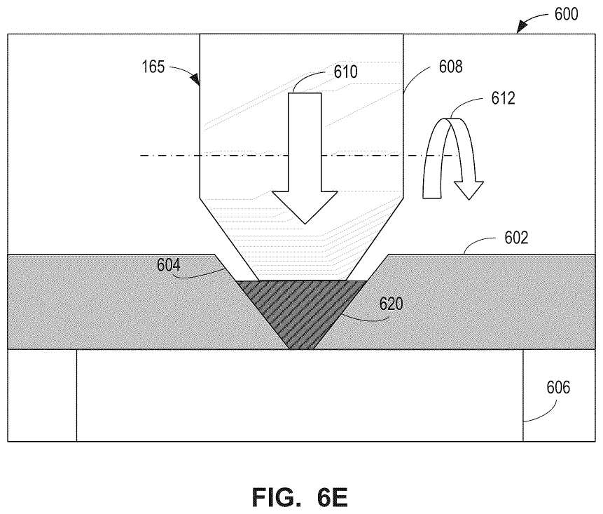

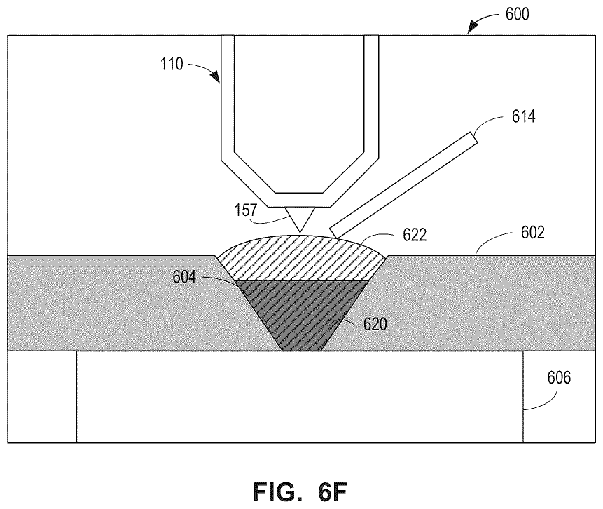

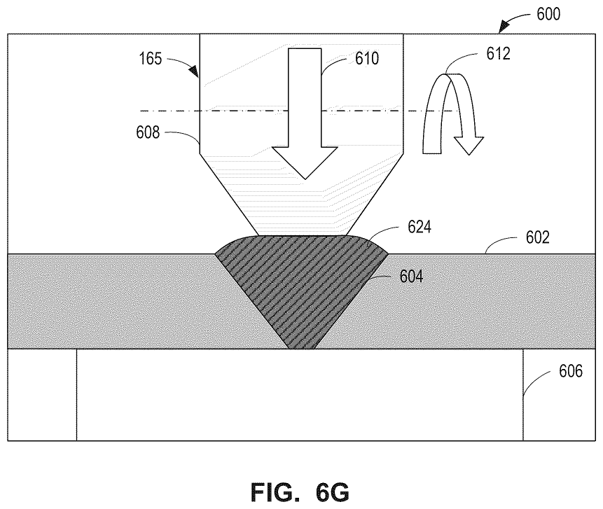

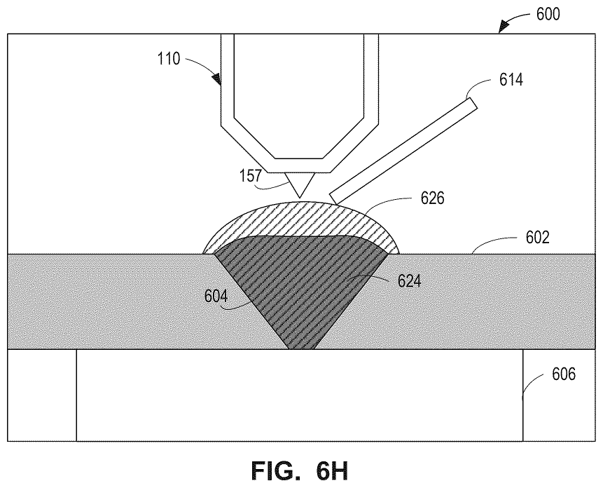

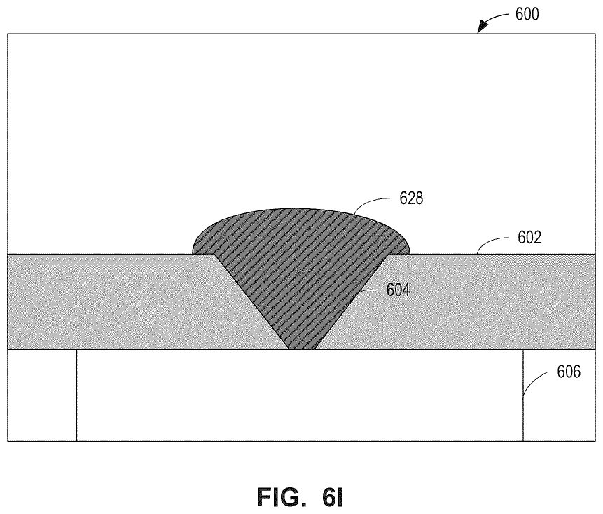

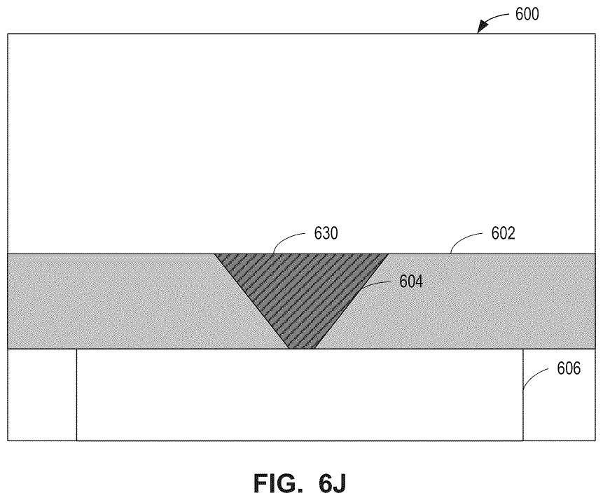

FIG. 6A is a diagram of an example configuration 600 of the system 150 showing, in operation, preparation of a part 602 to be built and/or modified. In the illustrated example of FIG. 6A, the roller 165 of the system 150 prepares the part 602 to be built and/or modified. In this example, the part 602 is not contiguous and has an example weld region 604. Further, the part 602 is composed of a first crystalline structure (e.g., grain size, microstructure, etc.). The part 602 is located so that the weld region 604 is between an example inner roller 606 and an example outer roller 608. In this example, the weld region 604 is represented by a gap in the part 602. In other examples, the weld region 604 may be an area that the user wishes to modify, repair, build, fabricate, or otherwise weld. In the illustrated example of FIG. 6A, the outer roller 608 compresses the part 602 at the weld region 604 to prepare the region for welding. In some examples, the compression of the part 602 at the weld region 604 is an optional procedure that may be implemented based on the type of material of the part 602 and/or the feedstock material. The compression of the part 602 at the weld region 604 reduces tensile stress for material later deposited in the weld region 604 during the welding process. Therefore, pre-compression reduces the probability of cracks for materials deposited in the weld region 604. Due to this reduction in the probability of cracks, pre-compression is particularly useful for materials that are difficult to weld (e.g., Waspaloy®, etc.). In this example, the compression by the outer roller 608 occurs in a first direction 610 perpendicular to the part 602 and translationally in a second direction 612 to prepare the area for welding. In some examples, the compression by the outer roller 608 in the second direction 612 occurs in the direction of the formation of a bead region (e.g., in a longitudinal direction as shown in FIG. 2, in a circumferential direction as shown in FIG. 3, or in any other direction of formation of the bead region).

FIG. 6B is a diagram of an example configuration 600 of the system 150 showing, in operation, deposition of feedstock material 614 into the weld region 604. In the illustrated example of FIG. 6B, the additive manufacturing machine 110 of the system 150 deposits the feedstock material 614 into the weld region 604 via the deposition head 157. In this example, the feedstock material 614 forms a first layer 616 deposited at a first temperature. In some examples, the first temperature is the melting temperature of the feedstock material 614 and/or the part 602.

FIG. 6C is a diagram of an example configuration 600 of the system 150 showing, in operation, compression of the first layer 616. In the illustrated example of FIG. 6C, the roller 165 compresses the first layer 616 between the outer roller 608 and the inner roller 606. The roller 165 compresses the first layer 616 in the first direction 610 and the second direction 612. The compression of the first layer 616 forms a first compressed layer 616.

FIG. 6D is a diagram of an example configuration 600 of the system 150 showing, in operation, deposition of a second layer 618. In the illustrated example of FIG. 6D, the additive manufacturing machine 110 deposits the feedstock material 614 into the weld region 604 via the deposition head 157. In this example, the feedstock material 614 forms the second layer 618 deposited at a second temperature. The second layer 618 is deposited at a second temperature which heats the first compressed layer 616 (e.g., the second temperature is higher than the first temperature at the time of deposition of the second layer 618). In some examples, the additive manufacturing machine 110 deposits the second layer 618 at the second temperature, such that the second temperature is the same temperature as the first temperature at the time of deposition of the first layer 616. In some examples, the second temperature is the melting temperature of the feedstock material 614 and/or the part 602. The second layer 618 heats the first compressed layer 616 and activates recrystallization in the first compressed layer 616. After heating by the second layer 618, the first compressed layer 616 is recrystallized to match the material properties and microstructure of the rest of the part 602 (e.g., the first compressed layer 616 is recrystallized to have the first crystalline structure of the part 602).

FIG. 6E is an example configuration 600 of the system 150 showing, in operation, compression of the second layer 618 into the first compressed layer 616. In the illustrated example of FIG. 6E, the roller 165 compresses the second layer 618 into the first compressed layer 616 to form a second compressed layer 620. In this example, the roller 165 compresses in the first direction 610 and the second direction 612.

FIG. 6F is an example configuration 600 of the system 150 showing, in operation, deposition of a third layer 622. In the illustrated example of FIG. 6F, the additive manufacturing machine 110 deposits the feedstock material 614 into the weld region 604 on top of the second compressed layer 620 via the deposition head 157. In this example, the feedstock material 614 forms the third layer 622 deposited at a third temperature. The third layer 622 is deposited at the third temperature which heats the second compressed layer 620 (e.g., the third temperature is higher than the second temperature and the first temperature at the time of deposition of the third layer 622). In some examples, the additive manufacturing machine 110 deposits the third layer 622 at the third temperature, such that the third temperature is the same temperature as the first temperature at the time of deposition of the first layer 616. In some examples, the third temperature is the melting temperature of the feedstock material 614 and/or the part 602. Since the third layer 622 is at the third temperature, the third layer 622 heats the second compressed layer 620 to activate recrystallization in the second compressed layer 620. After heating by the third layer 622, the second compressed layer 620 is recrystallized to match the material properties and microstructure as the rest of the part 602 (e.g., the second compressed layer 620 is recrystallized to have the first crystalline structure of the part 602).

FIG. 6G is an example configuration 600 of the system 150 showing, in operation, compression of the third layer 622 into the second compressed layer 620. In the illustrated example of FIG. 6G, the roller 165 compresses the third layer 622 into the second compressed layer 620 to form a third compressed layer 624.

FIG. 6H is an example configuration 600 of the system 150 showing, in operation, deposition of a fourth layer 626. In the illustrated example of FIG. 6H, the additive manufacturing machine 110 deposits the feedstock material 614 into the weld region 604 on top of the third compressed layer 624. The feedstock material 614 forms the fourth layer 626 deposited at a fourth temperature (e.g., the fourth temperature is higher than the first temperature, the second temperature, and the third temperature at the time of deposition of the fourth layer 626). In some examples, the additive manufacturing machine 110 deposits the fourth layer 626 at the fourth temperature, such that the fourth temperature is the same temperature as the first temperature at the time of deposition of the first layer 616. In some examples, the fourth temperature is the melting temperature of the feedstock material 614 and/or the part 602. The fourth layer 626 heats the third compressed layer 624 and activates recrystallization in the third compressed layer 624. After heating by the fourth layer 626, the third compressed layer 624 is recrystallized to match the material properties and microstructure of the rest of the part 602 (e.g., the second compressed layer 620 is recrystallized to have the first crystalline structure of the part 602).

FIG. 6I is an example configuration 600 of the system 150 showing, in operation, formation of a fifth layer 628 on the part 602. In the illustrated example of FIG. 6I, the fourth layer (e.g., the fourth layer of FIG. 6H) has cooled to the same temperature as the previously deposited material (e.g., the third compressed layer 624 of FIG. 6H) to form the fifth layer 628. In this example, the fifth layer 628 forms a bead region slightly taller than the part 602 (e.g., the volume of material in the weld region exceeds the volume of the weld region). However, in other examples, the fifth layer 628 may not protrude from the weld region 604 or is otherwise shaped within and/or outside the weld region 604.

FIG. 6J is an example configuration 600 of the system 150 showing, in operation, machining of the fifth layer 628. In the illustrated example of FIG. 6J, the fifth layer 628 is machined (e.g., trimmed away) by the post-processing device 130 so that it is level with the part 602. After the fifth layer 628 is machined by the post-processing device 130, a finished region 630 remains in the weld region 604 of the part 602.

In some examples, a thermal heat treatment (e.g., via the heating/cooling device 136) can be applied to the finished region 630 to maximize material properties. In these examples, the finished region 630 is typically composed of a nickel alloy.

Flowcharts representative of example machine-readable instructions, which may be executed by programmable circuitry to implement and/or instantiate the additive manufacturing apparatus 100 of FIG. 1A and/or representative of example operations which may be performed by programmable circuitry to implement and/or instantiate the controller circuitry 120 of FIG. 1A are shown in FIGS. 7-10. The machine-readable instructions may be one or more executable programs or portion(s) of one or more executable programs for execution by programmable circuitry such as the programmable circuitry 1112 shown in the example programmable circuitry platform 1100 discussed below in connection with FIG. 11 and/or may be one or more function(s) or portion(s) of functions to be performed by example programmable circuitry (e.g., an FPGA). In some examples, the machine-readable instructions cause an operation, a task, etc., to be conducted and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 7-10, many other methods of implementing the example ladditive manufacturing apparatus 100 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 7-10 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

FIG. 7 is a flowchart representative of example machine-readable instructions and/or example operations 700 that may be executed, instantiated, and/or performed by programmable circuitry to build and/or modify (e.g., repair, combine, etc.) a component, such as the component 140.

The example machine-readable instructions and/or the example operations 700 of FIG. 7 begin at block 710, at which the controller circuitry 120 causes the system 150 to prepare the component 140 for build/modification. Preparation of the component 140 for build and/or modify is especially important in examples where difficult to weld materials are utilized (e.g., Waspaloy). Preparation of the component 140 includes deforming (e.g., applying material strain) to the component 140 prior to deposition of feedstock material and/or application of a heat source to the component 140. By applying material strain to the component 140 prior to further additive manufacturing, the component 140 and/or the material deposited in the weld region is less prone to cracks during fusion. In some examples, a user operating the additive manufacturing machine 110 may opt to prepare the component 140 for build/modification. In other examples, preparation may be triggered upon detection by the additive manufacturing machine 110 of a difficult to weld material as the component 140.

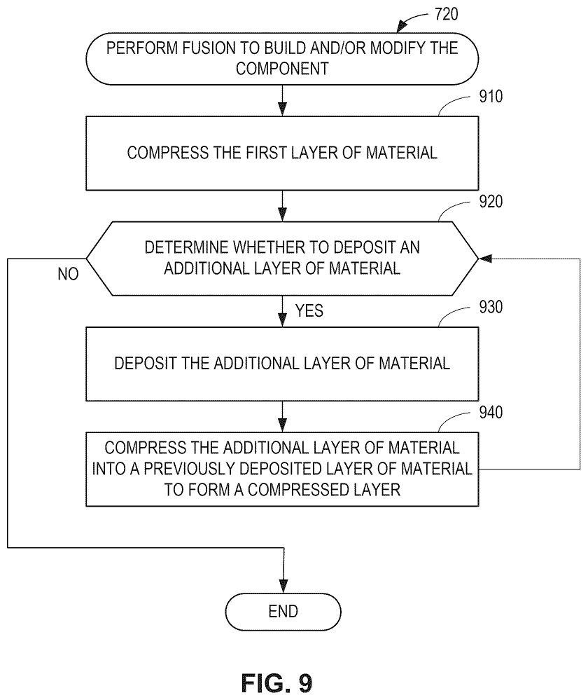

Then, at block 720, the controller circuitry 120 causes the system 150 to perform fusion to build and/or modify the component 140. As described in greater detail with FIG. 9, the fusion process includes deposition of feedstock material, and compression of the layer of feedstock material. In some examples, the fusion process can include application of a heat source to heat the component 140 to a melting point, and compression of the layer of melted material of the component 140. The deposition of a layer of material, compression of the layer of material, and deposition of an additional layer of material at a certain temperature onto the component 140 allows for static recrystallization of the material in the weld region (e.g., such as the weld region 604 of FIGS. 6A-6J) so that the grain size of the material in the weld region may suit the grain size of the component 140 (e.g., the material in the weld region and the component 140 have similar microstructure and/or crystalline structure). In some examples, deposition and compression of layers of material is repeated until the desired configuration of the weld region is achieved. In some examples, the additive manufacturing machine 110 deposits the feedstock material into the weld region, and then the roller 165 compresses the feedstock material in the weld region. In some examples, the heating/cooling device 136 of the post-processing device 130 can be utilized to adjust the temperature of the deposited material in the weld region prior to or after compression to further control static recrystallization.

Lastly, at block 730, the controller circuitry 120 causes the system 150 to finish the component 140, resulting in an output of the component 140 for use. Based on the application of the component 140, the post-processing device 130 can be applied to shape the deposited material of the weld region. In some examples, the feedstock material can be deposited into the weld region of the component 140 so that a portion of the deposited material bulges over the component 140 (as shown in FIG. 6I). In that example, the cutting/trimming device 132 and/or polishing device 138 can be applied to smooth the portion of the deposited material that bulges over the component 140 so that it is even with the component 140. In some examples, the scanning device 134 scans the component 140 for defects and/or areas that can be further configured to suit the application of the component 140.

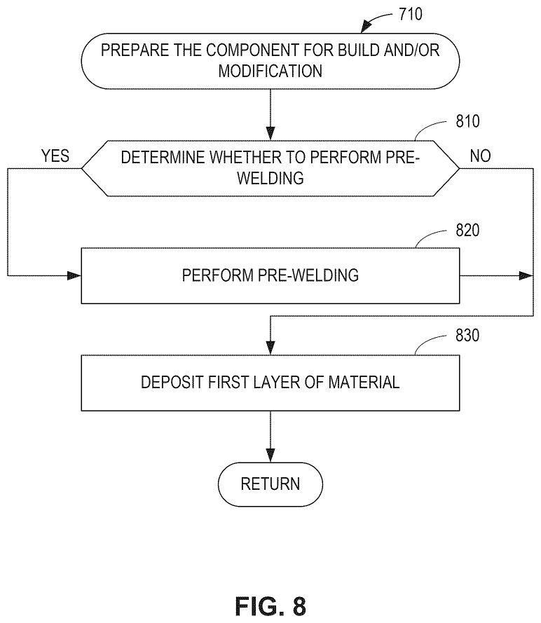

FIG. 8 is a flowchart representative of example machine-readable instructions and/or example operations 710 that may be executed, instantiated, and/or performed by programmable circuitry to prepare a component for build and/or modification. The example machine-readable instructions and/or the example operations 710 of FIG. 8 begin at block 810, at which the controller circuitry 120 determines whether to perform pre-welding. As described above, “pre-welding” is the process by which the roller 165 applies compression to the component prior to deposition of a layer of material by the additive manufacturing machine 110. In some examples, the determination for whether to perform pre-welding is based on the material of the component 140. If the component 140 is comprised of a material that is difficult to weld (e.g., nickel-based alloys such as Waspaloy®, Alloy 59, Alloy 625, Alloy 718, Alloy 939, Alloy 738, Alloy 247, etc.), the determination to perform pre-welding is beneficial to reduce the risk of cracks from the tensile stress of the next-deposited metal. Further, in some examples, the controller circuitry 120 can send a notification to the user or seek user input for whether to perform pre-welding.

If the controller circuitry 120 determines not to perform pre-welding (block 810: NO), then control proceeds to block 830. If the controller circuitry 120 determines to perform pre-welding (block 810: YES), then control proceeds to block 820.

At block 820, the controller circuitry 120 causes the system 150 to perform pre-welding. The controller circuitry 120 performs pre-welding by compressing the component 140, via the roller 165, prior to deposition of material (as shown, for example, in FIG. 6A). The compression of the material prior to deposition reduces the risk that the tensile stress from a subsequent weld deposit will produce cracks in the component. The strain produced in the component 140 prior to welding as a result of this compression allows for the feedstock material to be deposited with a lesser risk of cracks forming in the deposited layer of feedstock material and/or the component 140. Then, after the controller circuitry 120 performs pre-welding, control proceeds to block 830.

At block 830, the controller circuitry 120 causes the additive manufacturing machine 110 to deposit a first layer of material (as shown, for example, in FIG. 6B). The type of material of the first layer of material is based on the material of the component being modified, and the modification desired. In some examples, the first layer of material can be composed of the same material as the component 140. However, based on the application of the component 140 and the desired strength of the material in the weld region, the feedstock material can be changed. Therefore, in applications where a flexible weld is desired, such as when the weld region is in an area of a curve in the component 140, a feedstock material that allows for bending can be used. In other examples where a rigid weld is desired, such as when the weld region is in an area of the component 140 that is under stress, the feedstock material can be composed of the same material as the component 140 and/or a more rigid material. The controller circuitry 120 causes the additive manufacturing machine 110 to deposit the first layer of a material with a first crystalline structure at a first temperature. After the controller circuitry 120 causes the deposition of a first layer of material, control returns to block 720.

FIG. 9 is a flowchart representative of example machine-readable instructions and/or example operations 720 that may be executed, instantiated, and/or performed by programmable circuitry to perform fusion to build and/or modify the component. The example machine-readable instructions and/or the example operations 720 of FIG. 9 begin at block 910, where the controller circuitry 120 causes the roller 165 to compress the first layer of material (as shown, for example, in FIG. 6C) to form a first compressed layer of material. In some examples, the controller circuitry 120 causes the roller 165 to compress the first layer of material a specific time after the deposition of the first layer of material. In this example, the controller circuitry 120 causes the roller 165 to compress the first layer of material after the first layer of material has had a certain amount of time to decrease temperature and/or after the first layer of material has been acted on by the heating/cooling device 136 of the post-processing device 130. After compression of the first layer of material, control proceeds to block 920.

At block 920, the controller circuitry 120 determines whether to deposit an additional layer of material. In some examples, the determination of whether to deposit an additional layer of material is based on a computer model of the build and/or modification desired for the component. Additionally and/or alternatively, the determination of whether to deposit an additional layer of material can be based on the number of layers, thickness of the component and/or the deposited layers, and strength (e.g., stiffness) of the component and/or the deposited layers. In examples where the determination of whether to deposit an additional layer of material is based on the number of layers there may be any number of layers (e.g., a second layer, a third layer, a fourth layer, a fifth layer, an nth layer, etc.). In other examples, the determination of whether to deposit an additional layer of material can be based on user input, a build configuration file, and/or other set parameters.

If the controller circuitry 120 determines not to deposit an additional layer of material (block 920: NO), then the operations 720 terminate and control returns to block 730. If the controller circuitry 120 determines to deposit an additional layer of material (block 920: YES), then control proceeds to block 930.

Then, at block 930, the controller circuitry 120 causes the additive manufacturing machine 110 to deposit the additional layer of material. In some examples, the additive manufacturing machine 110 deposits the additional layer of material on top of the first layer of material (as shown, for example, in FIG. 6D). In other examples, the additive manufacturing machine 110 deposits the additional layer of material on top of the previously deposited layer of material (e.g., a second layer of material, a third layer of material, a fourth layer of material, an nth layer of material, etc.). In this manner, the additive manufacturing machine 110 deposits the additional layer of material at a temperature on top of the first layer of material, which heats the first layer of material (e.g., the previously deposited layer of material) and changes the first temperature based on the temperature of the additional layer (e.g., a second layer of material has a second temperature that is higher than the first temperature, a third layer of material has a third temperature that is higher than the first temperature and/or second temperature, an nth layer of material has an n temperature that is higher than the temperature of a previously deposited layer, etc.). In some examples, the additional layer of material is deposited at a temperature higher than the first temperature to heat the first layer of material and cause further grain refinement and recrystallization of the first layer of material. In other examples, the additional layer of material is deposited at a temperature lower than the first temperature so that the additional layer of material is heated by the first layer of material (i.e., the first layer of material is cooled by the additional layer of material) causing further grain refinement and recrystallization of the first layer of material. After the deposition of the additional layer of material on top of a previously deposited layer of material (e.g., a second layer of material, a third layer of material, a fourth layer of material, etc.), the previously deposited layer of material includes the first crystalline structure. In some examples, after deposition of the additional layer of material at a certain temperature, static recrystallization occurs in the previously deposited layer causing grain refinement to that of the component 140. Further, in some examples, the previously deposited layer of material recrystallizes to include the first crystalline structure. As described above, in some examples, the component 140 has a microstructure including the first crystalline structure. After the deposition of the additional layer of material, control proceeds to block 940.

Then, at block 940, the controller circuitry 120 causes the roller 165 to compress the additional layer of material into a previously deposited layer of material to form a compressed layer (as shown, for example, in FIG. 6E). In some examples, the controller circuitry 120 causes the roller 165 to compress the additional layer of material to form a second compressed layer. Further, the controller circuitry 120 can cause the roller 165 to compress the additional layer of material to form a third compressed layer. In some examples, the controller circuitry 120 causes the roller 165 to compress the additional layer of material a specific time after the deposition of the additional layer of material. In this example, the controller circuitry 120 causes the roller 165 to compress the additional layer of material after the additional layer of material has had a certain amount of time to decrease temperature and/or after the additional layer of material has been acted on by the heating/cooling device 136 of the post-processing device 130. After compression of the additional layer of material into a previously deposited layer of material to form a compressed layer, control proceeds to block 920.

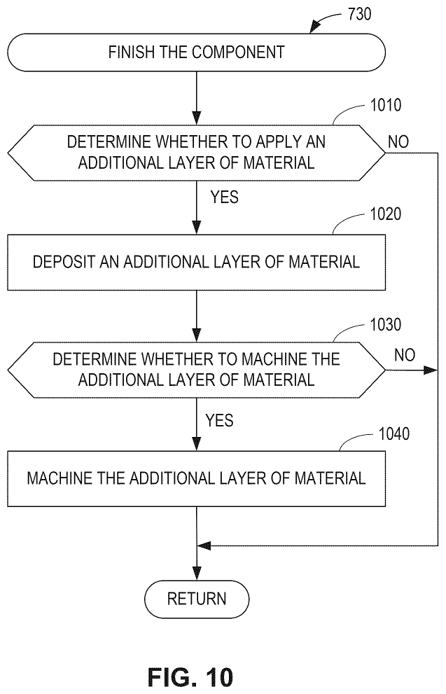

FIG. 10 is a flowchart representative of example machine-readable instructions and/or example operations 730 that may be executed, instantiated, and/or performed by programmable circuitry to finish the component 140 for output. The example machine-readable instructions and/or the example operations 730 of FIG. 10 begin at block 1010, where the controller circuitry 120 determines whether to apply an additional layer of material. The determination of whether to apply an additional layer of material is based on whether extra material is required to modify the component after the recrystallization of the previous layers is accomplished. Further, the determination of whether to apply an additional layer of material can be based on the application of the component 140. In instances where the weld region of the component 140 should be concave, an additional layer of material may not be applied. In examples where the weld region of the component 140 should be convex, an additional layer of material may be applied.

If the controller circuitry 120 determines not to apply an additional layer of material (block 1010: NO), then control proceeds to block 730. If the controller circuitry 120 determines to apply an additional layer of material (block 1010: YES), then control proceeds to block 1020.

At block 1020, the controller circuitry 120 causes the additive manufacturing machine 110 to deposit an additional layer of material (as shown, for example, in FIG. 6H). The additive manufacturing machine 110 deposits the additional layer of material at a temperature (e.g., a second temperature, a third temperature, a fourth temperature, an nth temperature, etc.). In some examples, the controller circuitry 120 may wait to proceed until the material in the weld region has cooled to a uniform temperature (as shown, for example, in FIG. 6I). After the additive manufacturing machine 110 deposits the additional layer of material, control proceeds to block 1030 where the controller circuitry 120 determines whether to machine the additional layer of material. The determination of whether to machine the additional layer of material can be based on the desired shape of the additional layer of material in reference to the component, the desired application of the component as modified, and/or the aesthetic nature of the weld region of the component. In some examples, the controller circuitry 120 may determine to machine the additional layer of material if the additional layer of material is not even with the component surrounding the modified area. In some examples, the controller circuitry 120 may determine whether to machine the additional layer of material based on user input and/or the desired modification of the component.

If the controller circuitry 120 determines not to machine the additional layer of material (block 1030: NO), control proceeds to block 730. If the controller circuitry 120 determines to machine the additional layer of material (block 1030: YES), control proceeds to block 1040. At block 1040, the controller circuitry 120 causes the post-processing device 130 to machine the additional layer of material (as shown, for example, in FIG. 6J). In some examples, the cutting/trimming device 132 and/or the polishing device 138 of the post-processing device 130 can machine the additional layer of material. Further, in some examples, the scanning device 134 of the post-processing device 130 can scan the component 140 to ensure that machining of the component 140 did not produce defects in the structure of the component and/or that further machining is not desired. After completion of the machining of the additional layer of material, control returns to block 730.

FIG. 11 is a block diagram of an example programmable circuitry platform 1100 structured to execute and/or instantiate the example machine-readable instructions and/or the example operations of FIGS. 7-10 to implement the additive manufacturing apparatus 100 of FIG. 1A. The programmable circuitry platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a headset (e.g., an augmented reality (AR) headset, a virtual reality (VR) headset, etc.) or other wearable device, or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, and/or microcontrollers from any desired family or manufacturer. The programmable circuitry 1112 may be implemented by one or more semiconductor based (e.g., silicon based) devices. In this example, the programmable circuitry 1112 implements the controller circuitry 120.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, etc. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1132, which may be implemented by the machine-readable instructions of FIGS. 7-10, may be stored in the mass storage device 1128, in the volatile memory 1114, in the non-volatile memory 1116, and/or on at least one non-transitory computer readable storage medium such as a CD or DVD which may be removable.

From the foregoing, it will be appreciated that example systems, apparatus, articles of manufacture, and methods have been disclosed that allow for modification of a material via induced strain and temperature control. Disclosed systems, apparatus, articles of manufacture, and methods improve the efficiency of using a computing device by improving formation and/or modification of a material via induced strain and temperature control. Disclosed systems, apparatus, articles of manufacture, and methods are accordingly directed to one or more improvement(s) in the operation of a machine such as a computer or other electronic and/or mechanical device.

Further aspects of the present disclosure are provided by the subject matter of the following clauses.

Example 1 includes a method to form a component, comprising depositing a first layer of material, the first layer of material at a first temperature, compressing the first layer of material to form a first compressed layer, depositing a second layer of material, the second layer of material at a second temperature, the first compressed layer to include a first crystalline structure, compressing the second layer of material into the first compressed layer to form a second compressed layer, depositing a third layer of material, the third layer of material at a third temperature, the second compressed layer to include the first crystalline structure, and compressing the third layer of material into the second compressed layer to form a third compressed layer.

Example 2 includes the method of any preceding clause, further including depositing a fourth layer of material, the fourth layer of material at a fourth temperature, the third compressed layer to include the first crystalline structure, and removing at least a portion of the fourth layer of material.

Example 3 includes the method of any preceding clause, wherein the component is between an outer roller and an inner roller.

Example 4 includes the method of any preceding clause, wherein the outer roller includes at least one of an adjustable load carrying structure, an actuator, a load cell, or a roller.

Example 5 includes the method of any preceding clause, wherein the inner roller includes at least one of an adjustable load carrying structure, a slotted segment, or a roller.

Example 6 includes the method of any preceding clause, wherein the inner roller has a convex shape at a first end, the first end disposed towards the component, and the outer roller has a concave shape at a second end, the second end disposed towards the component.

Example 7 includes the method of any preceding clause, wherein the component is repaired, modified, combined, or built.

Example 8 includes an apparatus comprising interface circuitry, an additive manufacturing machine to modify a layer of material, machine-readable instructions, and at least one processor circuit to be programmed by the machine-readable instructions to deposit a first layer of material on a component, the first layer of material at a first temperature, compress the first layer of material to form a first compressed layer, deposit a second layer of material, the second layer of material at a second temperature, the first compressed layer to include a first crystalline structure, compress the second layer of material into the first compressed layer to form a second compressed layer, deposit a third layer of material on the second compressed layer, the third layer of material at a third temperature, the second compressed layer to include the first crystalline structure, and compress the third layer of material into the second compressed layer to form a third compressed layer.

Example 9 includes the apparatus of any preceding clause, wherein the additive manufacturing machine modifies the third compressed layer by at least one of compressing the third compressed layer or applying a subsequent layer of material at a temperature, wherein the application of the subsequent layer of material causes recrystallization of the third compressed layer to include a crystalline structure of the component.

Example 10 includes the apparatus of any preceding clause, wherein the component is between an outer roller and an inner roller.

Example 11 includes the apparatus of any preceding clause, wherein the inner roller includes at least one of an adjustable load carrying structure, a slotted segment, or a roller.

Example 12 includes the apparatus of any preceding clause, wherein the inner roller has a convex shape at an end, the end disposed towards the component.

Example 13 includes the apparatus of any preceding clause, wherein the outer roller has a concave shape at an end, the end disposed towards the component.

Example 14 includes an additive manufacturing apparatus comprising at least one memory, machine-readable instructions, and processor circuitry to at least one of instantiate or execute the machine-readable instructions to deposit a first layer of material on a component, the first layer of material at a first temperature, compress the first layer of material to form a first compressed layer, deposit a second layer of material, the second layer of material at a second temperature, the first compressed layer to include a first crystalline structure, compress the second layer of material into the first compressed layer to form a second compressed layer, deposit a third layer of material on the second compressed layer, the third layer of material at a third temperature, the second compressed layer to include the first crystalline structure, and compress the third layer of material into the second compressed layer to form a third compressed layer.

Example 15 includes the additive manufacturing apparatus of any preceding clause, further including depositing a fourth layer of material, the fourth layer of material at a fourth temperature, the third compressed layer to include the first crystalline structure, and removing at least a portion of the fourth layer of material.

Example 16 includes the additive manufacturing apparatus of any preceding clause, wherein the component is between an outer roller and an inner roller.

Example 17 includes the additive manufacturing apparatus of any preceding clause, wherein the outer roller includes at least one of an adjustable load carrying structure, an actuator, a load cell, or a roller.

Example 18 includes the additive manufacturing apparatus of any preceding clause, wherein the inner roller includes at least one of an adjustable load carrying structure, a slotted segment, or a roller.

Example 19 includes the additive manufacturing apparatus of any preceding clause, wherein the inner roller has a convex shape at an end, the end disposed towards the component.

Example 20 includes the additive manufacturing apparatus of any preceding clause, wherein the outer roller has a concave shape at an end, the end disposed towards the component.

Example 21 includes an apparatus comprising controller circuitry to determine a deposition of a layer of material on a component, the deposition of a layer of material at a temperature.

Example 22 includes an apparatus comprising an additive manufacturing machine to modify the layer of material, the layer of material modified to have a first crystalline structure, the first crystalline structure to include a crystalline structure of the component.

Example 23 includes an apparatus comprising a table, the table to hold a component for modification; a deposition head, the deposition head configured to deposit a material; a roller, the roller configured to apply a force to the material; and a controller configured to cause the apparatus to: deposit, via the deposition head, a first layer of material on the component, the first layer of material at a first temperature; compress, via the roller, the first layer of material to form a first compressed layer; deposit, via the deposition head, a second layer of material, the second layer of material at a second temperature, the first compressed layer to include a first crystalline structure; compress, via the roller, the second layer of material into the first compressed layer to form a second compressed layer; deposit, via the deposition head, a third layer of material on the second compressed layer, the third layer of material at a third temperature, the second compressed layer to include the first crystalline structure; and compress, via the roller, the third layer of material into the second compressed layer to form a third compressed layer.

Example 24 includes the apparatus of any preceding clause, the apparatus modifies the third compressed layer by at least one of compressing, via the roller, the third compressed layer or applying a subsequent layer, via the deposition head, of material at a temperature, wherein applying the subsequent layer of material causes recrystallization of the third compressed layer to include a crystalline structure of the component.

Example 25 includes the apparatus of any preceding clause, wherein the roller includes an inner roller and an outer roller, and the component is between the outer roller and the inner roller.

Example 26 includes the apparatus of any preceding clause, wherein the inner roller includes at least one of an adjustable load carrying structure, a slotted segment, or a roller.

Example 27 includes the apparatus of any preceding clause, wherein the inner roller has a convex shape at an end, the end disposed towards the component.

Example 28 include the apparatus of any preceding clause, wherein the outer roller has a concave shape at an end, the end disposed towards the component.

Example 29 includes the apparatus of any preceding clause, wherein the table rotates the component during deposition and compression.

Example 30 includes the apparatus of any preceding clause, wherein the deposition head and the roller are attached to an arm and positioned by the arm prior to deposition and compression of the component.

Example 31 includes the apparatus of any preceding clause, wherein the roller includes an actuator, the actuator to trigger the compression of the component.

Example 32 includes an apparatus comprising an additive manufacturing machine to modify a component, and a controller configured to cause the additive manufacturing machine to: deposit a first layer of material on a component, the first layer of material at a first temperature, compress the first layer of material to form a first compressed layer, deposit a second layer of material, the second layer of material at a second temperature, the first compressed layer to include a first crystalline structure, compress the second layer of material into the first compressed layer to form a second compressed layer, deposit a third layer of material on the second compressed layer, the third layer of material at a third temperature, the second compressed layer to include the first crystalline structure, and compress the third layer of material into the second compressed layer to form a third compressed layer.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A method to form a component, the method comprising:
depositing a first layer of material, the first layer of material at a first temperature;
compressing the first layer of material to form a first compressed layer;
depositing a second layer of material, the second layer of material at a second temperature, the first compressed layer to include a first crystalline structure;
compressing the second layer of material into the first compressed layer to form a second compressed layer;
depositing a third layer of material, the third layer of material at a third temperature, the second compressed layer to include the first crystalline structure; and
compressing the third layer of material into the second compressed layer to form a third compressed layer.

2. The method of claim 1, further including:
depositing a fourth layer of material, the fourth layer of material at a fourth temperature, the third compressed layer to include the first crystalline structure; and
removing at least a portion of the fourth layer of material.

3. The method of claim 1, wherein the component is disposed between an outer roller and an inner roller.

4. The method of claim 3, wherein the outer roller includes at least one of an adjustable load carrying structure, an actuator, a load cell, or a roller.

5. The method of claim 3, wherein the inner roller includes at least one of an adjustable load carrying structure, a slotted segment, or a roller.

6. The method of claim 3, wherein the inner roller has a convex shape at a first end, the first end disposed towards the component, and the outer roller has a concave shape at a second end, the second end disposed towards the component.

7. The method of claim 1, wherein the component is repaired, modified, combined, or built.

8. An apparatus, comprising:
a table, the table to hold a component for modification;
a deposition head, the deposition head configured to deposit a material;
a roller, the roller configured to apply a force to the material; and
a controller configured to cause the apparatus to:
deposit, via the deposition head, a first layer of material on the component, the first layer of material at a first temperature;
compress, via the roller, the first layer of material to form a first compressed layer;
deposit, via the deposition head, a second layer of material, the second layer of material at a second temperature, the first compressed layer to include a first crystalline structure;
compress, via the roller, the second layer of material into the first compressed layer to form a second compressed layer;
deposit, via the deposition head, a third layer of material on the second compressed layer, the third layer of material at a third temperature, the second compressed layer to include the first crystalline structure; and
compress, via the roller, the third layer of material into the second compressed layer to form a third compressed layer.

9. The apparatus of claim 8, wherein the apparatus modifies the third compressed layer by at least one of compressing, via the roller, the third compressed layer or applying a subsequent layer, via the deposition head, of material at a temperature, wherein applying the subsequent layer of material causes recrystallization of the third compressed layer to include a crystalline structure of the component.

10. The apparatus of claim 8, wherein the roller includes an outer roller and an inner roller, and the component is between the outer roller and the inner roller.

11. The apparatus of claim 10, wherein the inner roller includes at least one of an adjustable load carrying structure, a slotted segment, or a roller.

12. The apparatus of claim 10, wherein the inner roller has a convex shape at an end, the end disposed towards the component.

13. The apparatus of claim 10, wherein the outer roller has a concave shape at an end, the end disposed towards the component.

14. An additive manufacturing apparatus, comprising:
at least one memory;
machine-readable instructions; and
processor circuitry to at least one of instantiate or execute the machine-readable instructions to:
deposit a first layer of material on a component, the first layer of material at a first temperature;
compress the first layer of material to form a first compressed layer;
deposit a second layer of material, the second layer of material at a second temperature, the first compressed layer to include a first crystalline structure;
compress the second layer of material into the first compressed layer to form a second compressed layer;
deposit a third layer of material on the second compressed layer, the third layer of material at a third temperature, the second compressed layer to include the first crystalline structure; and
compress the third layer of material into the second compressed layer to form a third compressed layer.

15. The additive manufacturing apparatus of claim 14, further including:
depositing a fourth layer of material, the fourth layer of material at a fourth temperature, the third compressed layer to include the first crystalline structure; and
removing at least a portion of the fourth layer of material.

16. The additive manufacturing apparatus of claim 14, wherein the component is between an outer roller and an inner roller.

17. The additive manufacturing apparatus of claim 16, wherein the outer roller includes at least one of an adjustable load carrying structure, an actuator, a load cell, or a roller.

18. The additive manufacturing apparatus of claim 16, wherein the inner roller includes at least one of an adjustable load carrying structure, a slotted segment, or a roller.

19. The additive manufacturing apparatus of claim 16, wherein the inner roller has a convex shape at an end, the end disposed towards the component.

20. The additive manufacturing apparatus of claim 16, wherein the outer roller has a concave shape at an end, the end disposed towards the component.
